(19) United States
(12) Patent Application Publication
(10) Pub. No.: US 2022/0028123 A1
(43) Pub. Date: Jan. 27, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: MARI SAITO, TOKYO (JP); KENJI SUGIHARA, TOKYO (JP)

(21) Appl. No.: 17/309,414

(22) PCT Filed: Nov. 15, 2019
(86) PCT No.: PCT/JP2019/044902

§ 371 Date: May 26, 2021

(51) Int. Cl. G06T 11/00

(52) U.S. Cl. CPC G06T 11/00

(57) ABSTRACT

[Object] To provide an information processing apparatus, an information processing method, and a program capable of objectively confirming a state in which a wearing object selected by the user is virtually superimposed.

[Solving Means] An information processing apparatus of the present technology includes a control unit. The control unit displays an image superimposed on a display unit such that a wearing object selected by a user is virtually worn on a target different from the user. The control unit determines the target on which the wearing object is virtually superimposed on the basis of at least metadata of the wearing object.

### TECHNICAL FIELD

The present technology relates to an information processing apparatus, an information processing method, and a program. More particularly, the present technology relates to a technology of presenting an image in which a wearing object selected by a user is virtually superimposed on an arbitrary model to the user.

### BACKGROUND ART

In recent years, a technology has been disclosed in which clothing that a user wants to try on is displayed virtually on the user in a superimposed manner (for example, Patent Literature 1). In Patent Literature 1, various postures and parts of the user are accommodated, and a wearing comfort and the like are fed back to the user.

### CITATION LIST

### Patent Literature

Patent Literature 1: Japanese Patent Application Laid-open No. 2012-252437

### DISCLOSURE OF INVENTION

### Technical Problem

However, in the technology described in Patent Literature 1, when the clothing that the user wants to wear is virtually superimposed, a viewpoint of the user is limited, and a superimposed state can be confirmed only from the same viewpoint at all times. Thus, it is difficult for the user to objectively confirm the state in which the clothing is virtually superimposed on the user itself.

In view of the above-described circumstances, the present technology makes it possible to objectively confirm, for example, the state in which a wearing object selected by the user is virtually superimposed.

### Solution to Problem

In order to solve the above problems, an information processing apparatus according to an embodiment of the present technology includes a control unit.

The control unit displays an image superimposed on a display unit such that a wearing object selected by a user is virtually worn on a target different from the user.

The control unit determines the target on which the wearing object is virtually superimposed on the basis of at least metadata of the wearing object.

The control unit may determine the target on which the wearing object is virtually superimposed on the basis of the metadata of the wearing object and body size information of the user.

The control unit may select a target having a body size similar to a body size of the user as the target on which the wearing object is virtually superimposed.

The control unit may select a target depending on a type of the wearing object as the target on which the wearing object is virtually superimposed.

The control unit may select a target depending on a size of each part of the user as the target on which the wearing object is virtually superimposed.

The control unit may acquire metadata of a wearing object newly selected by a motion of the user, and determine the target on which the wearing object is virtually superimposed on the basis of at least the metadata.

The control unit may display on the display unit an image in which the wearing object is virtually superimposed on a virtual model, which is a target different from the user.

The control unit may determine an area in which the virtual model is present depending on the wearing object selected by the user.

The control unit may cause the virtual model to perform a motion depending on the wearing object selected by the user.

The control unit may display on the display unit an image in which a selected item selected by the user is virtually superimposed on a previously stored target.

The metadata may be information about at least one of a type, a size, a color, a material, or a price of the wearing object.

In order to solve the above problems, there is provided an information processing method of an information processing apparatus according to an embodiment of the present technology.

On the basis of at least metadata of a wearing object, a target on which the wearing object is virtually superimposed is determined.

An image superimposed such that the wearing object selected by a user is virtually worn on the target different from the user is displayed on a display unit.

In order to solve the above problems, a program according to an embodiment of the present technology causes an information processing apparatus to execute the following steps of:
determining a target on which a wearing object is virtually superimposed on the basis of at least metadata of the wearing object, and
displaying on a display unit an image superimposed such that the wearing object selected by a user is virtually worn on the target different from the user.

### BRIEF DESCRIPTION OF DRAWINGS

FIG. 1 is a block diagram showing a configuration example of a virtual superimposition system according to a first embodiment of the present technology.

FIG. 2 is a block diagram showing a configuration example of hardware of an information processing apparatus.

FIG. 3 is a conceptual diagram showing an example of metadata of a product.

FIG. 4 is a flowchart showing a process flow of the information processing apparatus according to the first embodiment.

FIG. 5 is a conceptual diagram showing an example in which a product is virtually superimposed on an arbitrary pedestrian.

FIG. 6 is a drawing showing body size information of a user and body size information of the pedestrian.

FIG. 7 is a block diagram showing a configuration example of a virtual superimposition system according to a second embodiment of the present technology.

FIG. 8 is a flowchart showing a process flow of an information processing apparatus according to the second embodiment.

FIG. 9 is a conceptual diagram showing an example in which a product is virtually superimposed on a virtual model.

FIG. 10 is a block diagram showing a configuration example of a virtual superimposition system according to a third embodiment of the present technology.

FIG. 11 is a flowchart showing a process flow of an information processing apparatus according to the third embodiment.

FIG. 12 is a conceptual diagram showing an example in which a product is virtually superimposed on an image.

### MODE(S) FOR CARRYING OUT THE INVENTION

Hereinafter, embodiments of the present technology will be described with reference to the drawings.

### First Embodiment

A virtual superimposition system according to the present embodiment is a system for specifying a model in accordance with data of a wearing object specified by a user, and virtually superimposing and displaying the data of the wearing object on the model. Hereinafter, an embodiment will be described on the assumption that the virtual superimposition system of the present technology is applied to an AR (Augmented Reality) device such as AR eyewear, and an AR device is used in a particular area such as a shopping area.

### [Configuration of Virtual Superposition System]

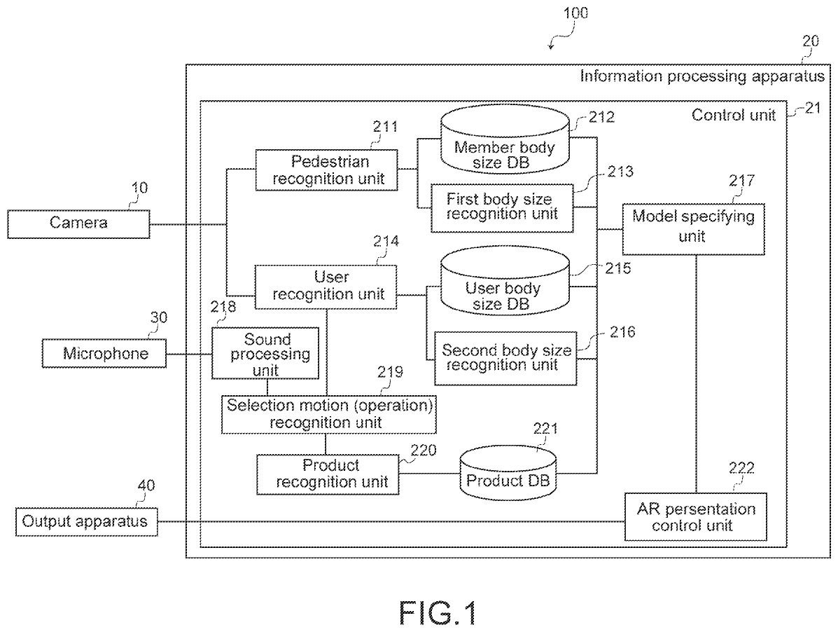

FIG. 1 is a block diagram showing a configuration example of a virtual superimposition system 100 according to the present embodiment. The virtual superimposition system 100 includes a camera 10, a microphone 30, an output apparatus 40, and an information processing apparatus 20, as shown in FIG. 1. Incidentally, the camera 10, the microphone 30, and the output apparatus 40 may be part of the information processing apparatus 20.

The camera 10 is a digital camera or a video camera having an image sensor such as, for example, a CCD (Charge Couple Devices) and a CMOS (Complementary Metal Oxide Semiconductor). The camera 10 is configured to be capable of generating an image (moving image) captured at a predetermined frame rate, and outputs image data to the information processing apparatus 20.

The microphone 30 converts a user's voice or the like into an electric signal, and outputs the signal (sound information) to the information processing apparatus 20. The output apparatus 40 includes an apparatus capable of notifying the user of acquired information using a sense of vision, hearing, tactile sense, or the like. The output apparatus 40 is an example of a “display unit” in Claims.

The output apparatus 40 is, for example, a display apparatus such as an LCD (Liquid Crystal Display) and an organic EL (Electro-Luminescence) display. The output apparatus 40 may output a result obtained by processing of the information processing apparatus 20, in addition to video such as text and image, sound such as voice and audio, vibration, or the like.

The information processing apparatus 20 causes the output apparatus 40 to display an image in which the wearing object selected by the user is virtually superimposed on an arbitrary model. Hereinafter, the configuration of the information processing apparatus 20 will be described. The information processing apparatus 20 may be any computer, such as a PC (Personal Computer), or may be a cloud server.

### (Hardware Configuration of Information Processing Apparatus)

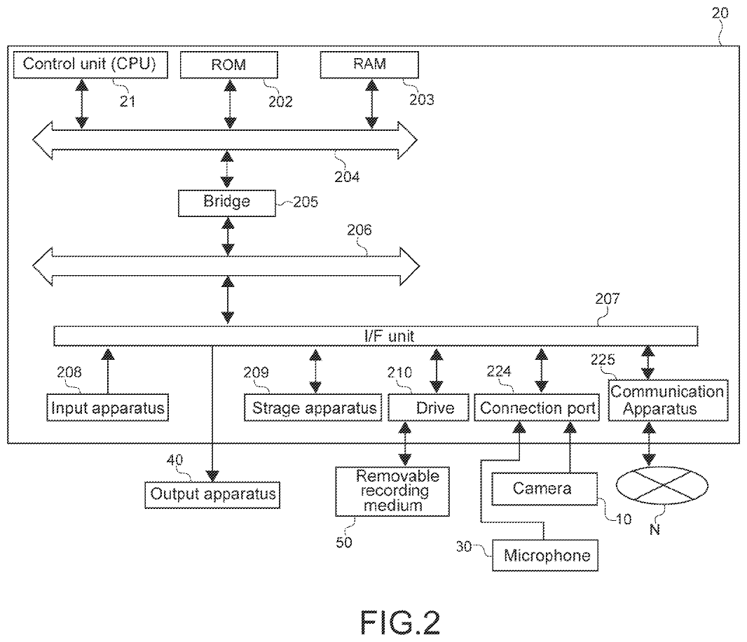

FIG. 2 is a block diagram showing an example of the hardware configuration of the information processing apparatus 20. The information processing apparatus 20 includes a control unit 21 (CPU (Central Processing Unit)), a ROM (Read Only Memory) 202, and a RAM (Random Access Memory) 203. The CPU is an example of a “control unit” in Claims.

In addition, the information processing apparatus 20 may include a host bus 204, a bridge 205, an external bus 206, an I/F unit 207, an input apparatus 208, a storage apparatus 209, a drive 210, a connection port 224, and a communication apparatus 225.

Furthermore, the information processing apparatus 20 may have processing circuits such as a DSP (Digital Signal Processor), an ASIC (Application Specific Integrated Circuit), and an FPGA (Field-Programmable Gate Array) instead of or in addition to the control unit 21 (CPU).

The control unit 21 (CPU) functions as an arithmetic processing unit and a control unit, and controls an overall operation of the information processing apparatus 20 or a part thereof in accordance with various programs recorded on the ROM 202, the RAM 203, the storage apparatus 209, or a removable recording medium 50.

The ROM 202 stores programs, arithmetic parameters and the like used by the control unit 21 (CPU). The RAM 203 temporarily stores programs used in executing the control unit (CPU) and parameters that are changed appropriately by execution. The control unit 21 (CPU), the ROM 202, and the RAM 203 are interconnected by the host bus 204 formed by an internal bus such as a CPU bus. In addition, the host bus 204 is connected via the bridge 205 to the external bus 206 such as a PCI (Peripheral Component Interconnect/Interface) bus.

The input apparatus 208 is an apparatus such as a touch panel, a button, a switch, and a lever operated by the user. The input apparatus 208 may be, for example, a remote control apparatus using infrared rays or other radio waves, or may be an externally connected device corresponding to an operation of the information processing apparatus 20. The input apparatus 208 includes an input control circuit that generates an input signal on the basis of information input by the user and outputs the input signal to the control unit 21 (CPU). By operating the input apparatus 208, the user inputs various data to the information processing apparatus 20 or instructs a processing operation.

The storage apparatus 209 is a data storage apparatus configured as an example of the storage unit of the information processing apparatus 20. The storage apparatus 209 includes, for example, a magnetic storage device such as an HDD (Hard Disk Drive), a semiconductor storage device, an optical storage device and a magneto-optical storage device. The storage apparatus 209 stores, for example, a program and various data that the control unit 21 (CPU) executes, and various data acquired from outside. The storage apparatus 209 may be cloud storage.

The drive 210 is a reader/writer for the removable recording medium 50 such as a magnetic disk, an optical disk, a magneto-optical disk, or a semiconductor memory, and is built in or externally attached to the information processing apparatus 20. The drive 210 reads out information recorded in the removable recording medium 50 and outputs the information to the RAM 203. Moreover, the drive 210 writes a record in the mounted removable recording medium 50.

The connection port 224 is a port for connecting the devices to the information processing apparatus 20. The connection port 224 may be, for example, a USB (Universal Serial Bus) port, an IEEE1394 port, an SCSI (Small Computer System Interface) port, or the like. Alternatively, the connection port 224 may be an RS-232C port, an optical audio terminal, the HDMI (High-Definition Multimedia Interface) (registered trademark) port, or the like. By connecting the camera 10 and the microphone 30 to the connection port 224, various data is output from the camera 10 and the microphone 30 to the information processing apparatus 20.

The apparatus 225 is, for example, a communication interface including a communication device for connecting to a network N. The communication apparatus 225 may be, for example, a communication card for a LAN (Local Area Network), the Bluetooth (registered trademark), a Wi-Fi, or a WUSB (Wireless USB).

In addition, the communication apparatus 225 may be a router for optical communication, a router for an ADSL (Asymmetric Digital Subscriber Line), or a modem for various types of communication. The communication apparatus 225 sends and receives a signal and the like to and from the Internet or other communication devices by using a predetermined protocol such as TCP/IP. Furthermore, the network N connected to the communication apparatus 225 is a network connected by wire or wireless, and may include, for example, the Internet, a home LAN, infrared communication, radio wave communication, satellite communication, or the like.

### (Function Configuration of Information Processing Apparatus)

The information processing device 20 (control unit 21) functionally includes a pedestrian recognition unit 211, a member body size DB 212, a first body size recognition unit 213, a user recognition unit 214, a user body size DB 215, a second body size recognition unit 216, a model specifying unit 217, a sound processing unit 218, a selection motion (operation) recognition unit 219, a product recognition unit 220, a product DB 221, and an AR presentation control unit 222.

The pedestrian recognition unit 211 recognizes, for example, a pedestrian (model) existing around the user in shopping. The member body DB 212 stores the body information of the pedestrian who is registered as a member in advance. The body size information is information relating to a height, a shirt length, a sleeve length, a waist circumference, a chest circumference, a foot size or an inside leg length of the user (pedestrian), and is also applied in the following description. The first body size recognition unit 213 recognizes the body size of the pedestrian on the basis of the image data acquired from the camera 10 capturing the image of the pedestrian and the body size information stored in the member body size DB 212. Furthermore, the first body size recognition unit 213 may estimate the body size information of the pedestrian on the basis of the image in which the pedestrian is captured, if the body size information of the pedestrian is not stored in the member size DB 212.

The user recognition unit 214 recognizes the user on the basis of, for example, the image data acquired from the camera 10 capturing the image of the user. The user body size DB 215 stores the body size information of the user registered in advance. The second body size recognition unit 216 recognizes the body size of the user on the basis of the image data acquired from the camera 10 capturing the image of the user and the body size information stored in the user body size DB 215. In addition, if the body size information of the user is not stored in the user body size DB 215, the second body size recognition unit 216 may estimate the body size information of the user on the basis of the captured image of the user.

The model specifying unit 217 specifies a model on which the product is virtually superimposed on the basis of metadata of the product registered in advance and the body size information of the user. Incidentally, the product is, for example, the wearing object worn by the user, and is also applied in the following description. The product is an example of a “wearing object” in Claims.

The sound processing unit 218 processes the sound information acquired from the microphone 30. The selection operation recognition unit 219 recognizes the motion (operation) of the user on the basis of the sound information acquired from the sound processing unit 218 and the image data acquired from the camera 10 capturing the motion of the user such as picking up, touching, or watching the product.

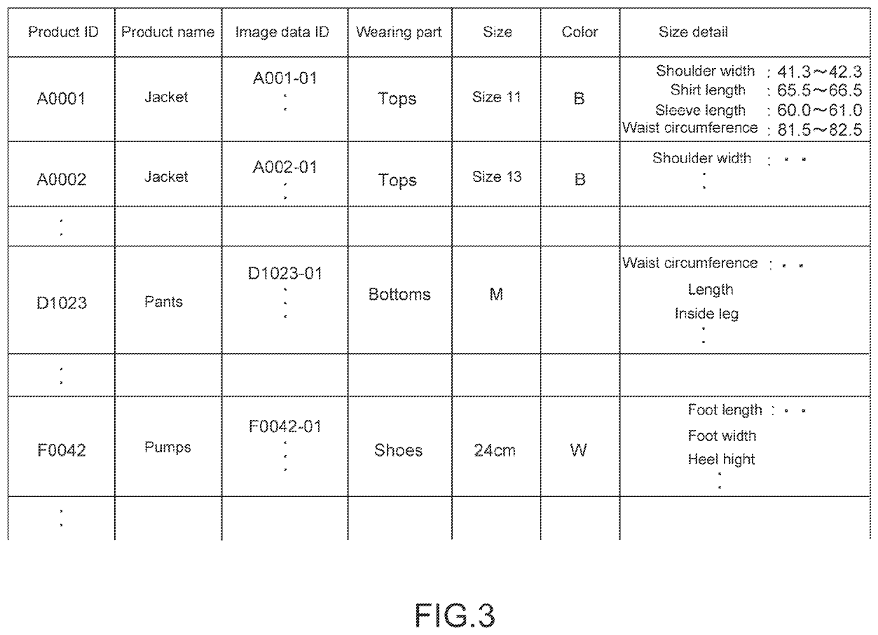

The product recognition unit 220 recognizes the product on the basis of the image data acquired from the camera 10 capturing the product. The product DB 221 stores the metadata of the product. The metadata is, for example, information about items worn on hands and feet of the user, or information about a size, a color variation, material and price of such items, or information about an application of such items, and is also applied in the following description. FIG. 3 is a conceptual diagram showing an example of such metadata.

The AR presentation control unit 222 causes the output apparatus 40 to display an image in which the product selected by the user is virtually superimposed on a model specified by the model specifying unit 217.

### [Information Processing Method]

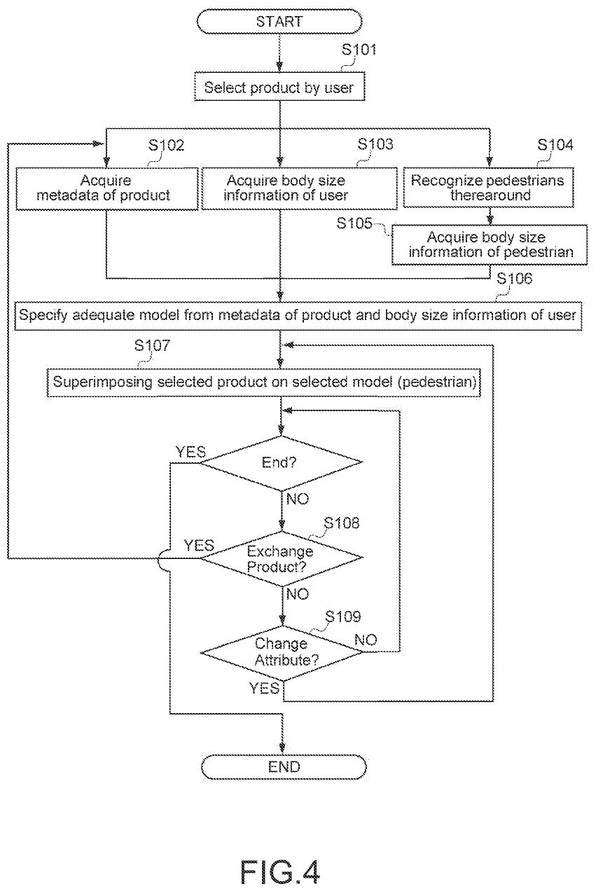

FIG. 4 is a flowchart showing a typical process flow of the information processing apparatus 20. Hereinafter, an outline of processing of the virtual superimposition system 100 will be described with reference to FIG. 4, as appropriate.

First, the user selects a specific product among several products (Step S101). In this case, a user's selection motion may include, for example, picking up, touching, or watching the specific product by the user. Alternatively, it may be an instruction pointing to the specific product and accompanied by a voice such as “this”, “it”, or the like.

Next, the user recognition unit 214 recognizes which user is the user who has taken the selection motion on the basis of the image data acquired from the camera 10 capturing the user's selection motion (which user is the user among the number of users registered in advance), and outputs a recognition result to the user body size DB 215, the second body size recognition unit 216, and the selection motion (operation) recognition unit 219.

The selection motion (operation) recognition unit 219 recognizes what selection motion the user has taken on the basis of the recognition result of the user recognition unit 214. Alternatively, the selection operation recognition unit 219 recognizes what selection motion the user has taken (what voice user has uttered) on the basis of an output of the sound processing unit 218.

On the basis of the recognition result of the selection motion (operation) recognition unit 219, the product recognition unit 220 recognizes what product the user has selected (tops, bottoms, or shoes), and outputs the recognition result to the product DB 221.

The product DB 221 picks up the metadata corresponding to the product recognized by the product recognition unit 220, and outputs the metadata to the model specifying unit 217. The model specifying unit 217 acquires the metadata relating to the product selected by the user (Step S102).

Furthermore, the user body size DB 215 picks up the body size information corresponding to the body size of the user recognized by the user recognition unit 214, and outputs the body size information to the model specifying unit 217. On the other hand, when the body size information of the user is not stored in the user body size DB 215, the second body size recognition unit 216 calculates (estimates) the body size information of the user by image recognition, and outputs the body size information to the model specifying unit 217. Thus, the model specifying unit 217 acquires the body size information of the user who has selected the specific product (Step S103).

Furthermore, the pedestrian recognition unit 211 recognizes a plurality of pedestrians on the basis of the image data acquired from the camera 10 capturing the images of the plurality of pedestrians (Step S104), and outputs the recognition result to the member body size DB 212 and the first body size recognition unit 213.

The member body size DB 212 picks up the body size information corresponding to the body size of each of the plurality of pedestrians recognized by the pedestrian recognition unit 211, and outputs the body size information to the model specifying unit 217. On the other hand, if the body size information of the pedestrian is not stored in the member size DB 212, the first body size recognition unit 213 calculates (estimates) the body size information of the pedestrian by image sensing or the like and outputs the body size information to the model specifying unit 217. Thus, the model specifying unit 217 acquires the body size information of the pedestrian existing around the user who has selected the specific product (Step S105).

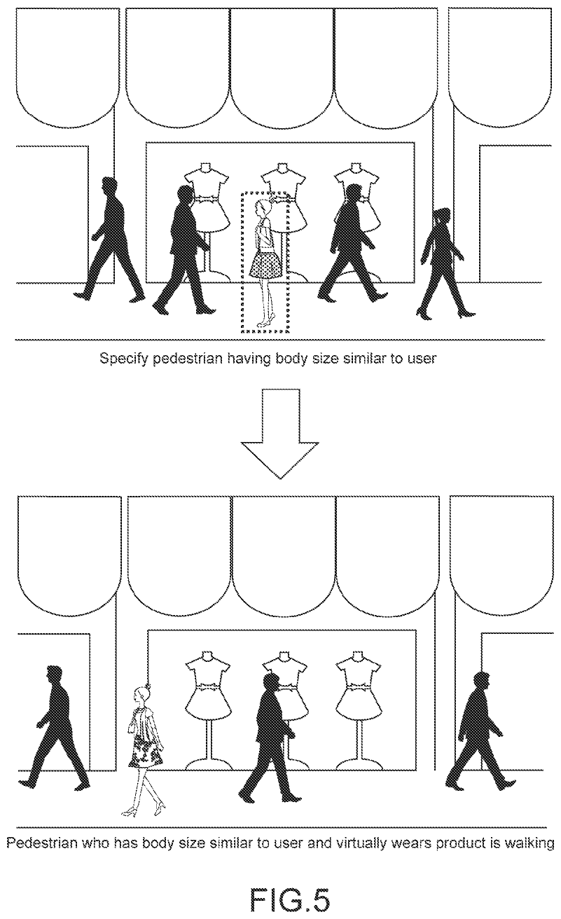

Next, the model specifying unit 217 selects a pedestrian having a body size similar to the user from among the plurality of pedestrians existing around the user (Step S106, FIG. 5). The pedestrian is an example of a “target” in Claims.

Specifically, the model specifying unit 217 extracts the body size information most similar to the body size information of the user from the body size information of each of the plurality of pedestrians acquired from the member body size DB 212 (first body size recognition unit 213) on the basis of the metadata of the product acquired from the product DB 221 and the body size information of the user acquired from the user body size DB 215 (second body size recognition unit 216). Then, the model specifying unit 217 identifies the pedestrian linked to the extracted body size information. At this time, priority conditions for extracting the body size information may be arbitrarily set by the user. For example, a priority order may be determined on the basis of information such as an age and a gender of the pedestrian.

Next, the model specifying unit 217 outputs the body size information of the pedestrian selected in Step S106, the body size information of the user acquired from the user body size DB 215, and the metadata acquired from the product DB 221 to the AR-presentation control unit 222.

The AR presentation control unit 222 generates an image in which the product selected by the user is virtually superimposed on the pedestrian selected by the model specific unit 217 on the basis of various information acquired from the model specifying unit 217 (Step S107), and displays the image on the output device 40. As a result, the user can objectively confirm the state in which the product is worn by the user itself. Therefore, before actually wearing the selected product, the user can determine whether or not to buy the product in consideration of a state assumed when the product is actually worn. FIG. 5 is a conceptual diagram showing an example in which the product is virtually superimposed on an arbitrary pedestrian. FIG. 5 shows an example in which the product selected by the user is a skirt.

Subsequently, if the user selects a different product from the product selected in Step S101 (YES in Step S108), the model specifying unit 217 newly acquires the metadata about the product selected by the user from the product DB 221. At this time, the selection motion of the user may include, for example, changing a product or directing a line of sight to another product. Alternatively, it may be an instruction pointing to a specific product and accompanied by a voice such as “white one at the back”, “one at right” or the like.

Next, by executing the processing similar to those in Steps S103 to S106, the model specifying unit 217 newly specifies a model (pedestrian) to be superimposed from the pedestrians existing around the user on the basis of the metadata of the product newly selected by the user and the user's body size information.

If an attribute of the product selected by the user is changed (YES in Step S109), the AR presentation control unit 222 newly generates an image in which the product having the attribute different from the product selected in Step S101 is virtually superimposed with respect to the pedestrian selected by the model specifying unit 217, and displays the image on the output apparatus 40. Changing the attribute means, for example, changing the size or color variation of the product selected by the user.

### [Modification]

In the first embodiment, a plurality of pedestrians may be selected for each type of the product if there is no pedestrian having a body size similar to the user's body size in the periphery.

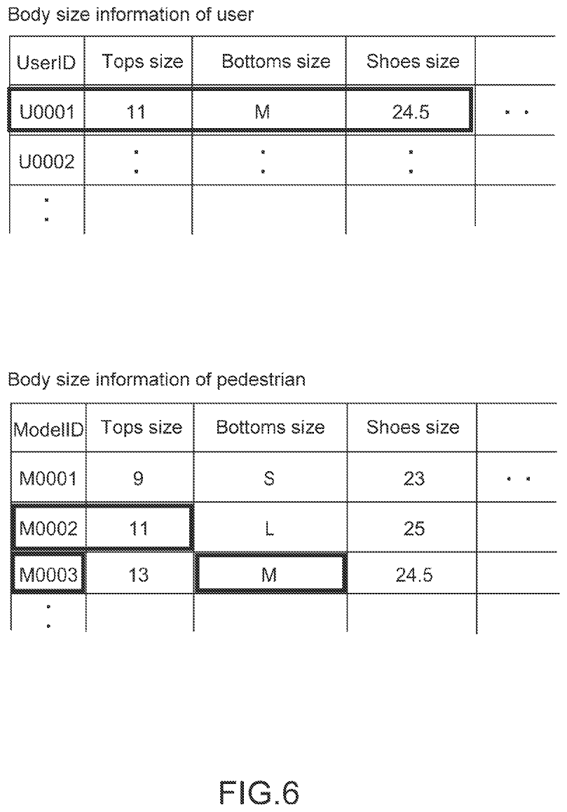

For example, referring to FIG. 6, if the body size information of the user is “Tops size 11”, “Bottoms size M”, and “Shoes size 24.5”, the pedestrian M0002 corresponding to the tops and the pedestrian M0003 corresponding to the bottoms are selected from the plurality of pedestrians. At this time, typically, the pedestrian having the same tops size as the user's tops size is selected, and the pedestrian having the same bottoms size as the user's bottoms size is selected. That is, a pedestrian is selected depending on the size of each site of the user.

In the first embodiment, the images of the pedestrian may be captured in advance from multiple viewpoints, and the pedestrian virtually superimposed on the product may be confirmed from various angles. In this case, the images of the pedestrian captured from the multiple viewpoints may be presented to the user, and may be selected by the selection motion by the user.

Furthermore, in the first embodiment, the pedestrian on which the product selected by the user is virtually superimposed may be limited. In this case, some incentives may be given to the pedestrian who has granted the superimposition. In addition, an area in which the product is virtually superimposed may be limited. For example, the product may be virtually superimposed only on pedestrians existing in a specific area such as a fashion mall, a fashion building, or a shopping mall.

In addition, the type of product virtually superimposed on the pedestrian may be limited. In this case, for example, an outerwear such as an outer is virtually superimposed on the pedestrian, but foods, daily necessities or undergarments are not virtually superimposed on the pedestrian.

In addition, in the first embodiment, in a case where it is difficult to specify a model to be superimposed, such as a case where there are many pedestrians around the user or a case where there is a pedestrian having a target size similar to that of the user at the end of the user's visual field, it may be highlighted by marking or lighting to which model the product is virtually superimposed.

In the first embodiment, the pedestrian (model) to be superimposed is selected on the basis of the metadata of the product and the body size information of the user, but it is not limited thereto. For example, if an accessory or the like worn around a face of the user is a product, the pedestrian may be selected on the basis of user's skin color, hair type, or face type data. Alternatively, the pedestrian may be selected on the basis of clothing worn by the user.

Furthermore, in the first embodiment, the target on which the product selected by the user is virtually superimposed is the pedestrian around the user, but it is not limited thereto. For example, an image in which the product selected by the user is virtually superimposed on an object such as a mannequin may be presented to the user. In this case, a posture and an orientation of the mannequin in the AR space may be changed by a user's gesture or the like, and the mannequin may be confirmed from various angles.

### Second Embodiment

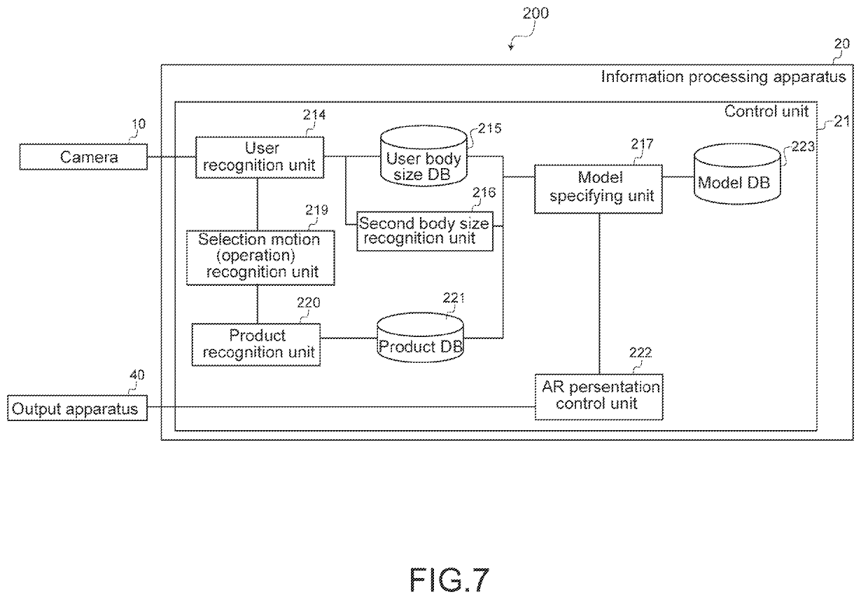

FIG. 7 is a block diagram showing a configuration example of a virtual superimposition system 200 according to the second embodiment of the present technology. Hereinafter, the same components as those of the first embodiment are denoted by the same reference numerals, and a description thereof will be omitted.

The second embodiment is different from the first embodiment in that the target on which the product selected by the user is virtually superimposed is a virtual model.

The information processing device 20 (control unit 21) according to the second embodiment functionally has a model DB 223. The model DB 223 stores the user's own body size information, a walking video, and the like.

### [Information Processing Method]

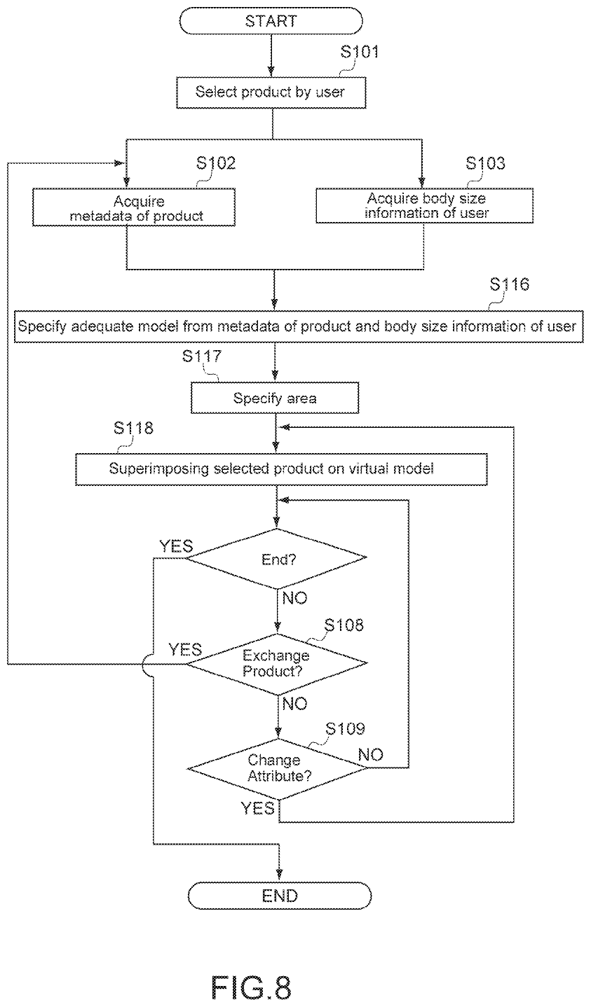

FIG. 8 is a flowchart showing a typical process flow of the information processing apparatus 20 according to the second embodiment. Hereinafter, an outline of processing of the virtual superimposition system 200 will be described with reference to FIG. 8, as appropriate. The same steps as those of the first embodiment are denoted by the same reference numerals, and the description thereof is omitted.

The model specifying unit 217 extracts the body size information most similar to the body size of the current user from the body size information stored in the model DB 223 on the basis of the metadata of the product acquired from the product DB 221 and the body size information of the user acquired from the user body DB 215 (second size body recognition unit 216) (Step S116), and outputs the body size information to the AR presentation control unit 222.

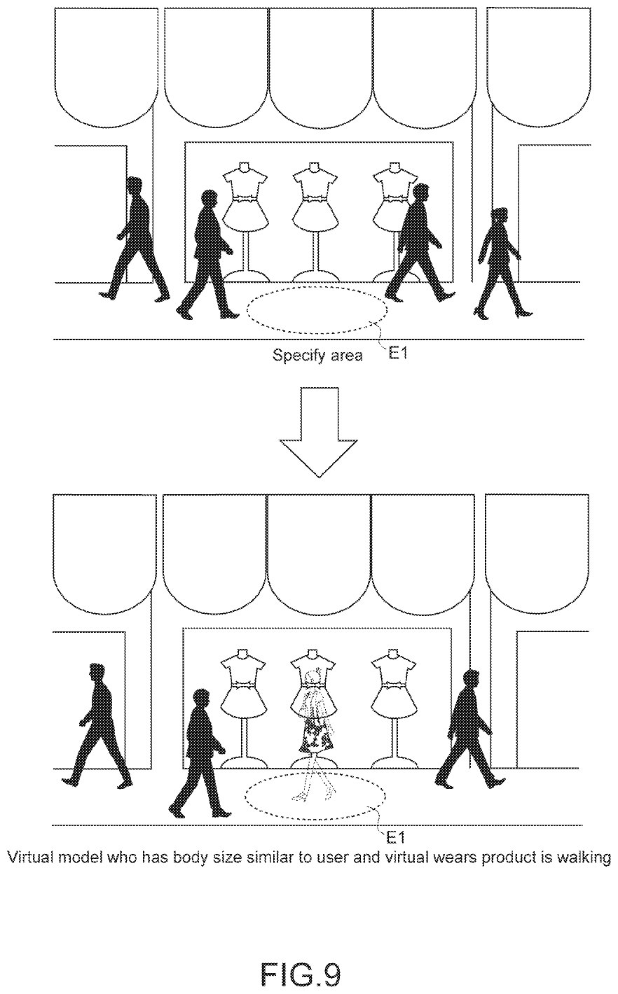

In addition, the model specifying unit 217 specifies an area E1 in which a virtual model having a similar body size to the user exists, in accordance with the product selected by the user (Step S117, FIG. 9). Specifically, the model specifying unit 217 determines a virtual position of the virtual model on the basis of the metadata of the product acquired from the product DB 221. At this time, typically, an area El which is not unnatural even if the virtual model exists is specified.

Next, the AR presentation control unit 222 generates the virtual model on the basis of the body size information acquired from the model specifying unit 217, and generates an image (moving image) in which the product selected by the user is virtually superimposed on the virtual model (Step S118). Then, the AR presentation control unit 222 displays the image on the output device 40. At this time, the virtual model may be caused to perform a motion corresponding to the product selected by the user. For example, if the product is shoes, the virtual model may be caused to walk in a place where the feet are easily visible by the user, or to perform an action such as kicking, stepping, or the like. FIG. 9 is a conceptual diagram showing an example in which the product is virtually superimposed on the virtual model. FIG. 9 shows an example in which the product selected by the user is a skirt.

### [Modification]

In the second embodiment, the virtual model is generated on the basis of the body size information of the user, but it is not limited thereto. For example, the virtual model may be generated on the basis of a user's walking video or the like captured in the past. Alternatively, if the pedestrian which is the superimposed target is no longer from the periphery of the user, the virtual model may be generated on the basis of the video in which the pedestrian is captured. Alternatively, the virtual model may be used, for example, the virtual model registered in advance in a shopping area where the user exists.

In the second embodiment, when the virtual model is caused to perform the motion corresponding to the product selected by the user, a moving image in which the virtual model moves may be arbitrarily selected, stopped, and rewound by the user. Alternatively, the user may arbitrarily set a walking speed, a step length, hand swinging, and the like of the virtual model.

Furthermore, in the second embodiment, when the virtual model is caused to perform an action corresponding to the product selected by the user, the virtual model may be caused to perform an action in which the user's own way of walking, habit (feature), or the like is reproduced.

In addition, in the second embodiment, although one body of the virtual model is typically generated, it is not limited to this and two or more bodies may be generated. By virtually superimposing different products on each of the plurality of virtual models, it becomes possible to simultaneously compare a plurality of types of products.

Furthermore, in the second embodiment, although the virtual model is generated on the basis of the body size information of the user itself, it is not limited thereto, and for example, the virtual model may be generated on the basis of the body size information of a person different from the user. As a result, even when an arbitrary person is not accompanied by the user, it is possible to confirm a state in which the product is virtually superimposed on the person. Therefore, convenience of purchasing the product worn by the person who is not accompanied by the user is improved.

In addition, in the second embodiment, an image in which the product is virtually superimposed on the virtual model of the mannequin adjusted to have a body size similar to that of the user may be presented to the user. In this case, the posture and the orientation of the virtual model in the AR space may be changed by the user's gesture, voice, or the like, and the mannequin may be confirmed from various angles.

### Third Embodiment

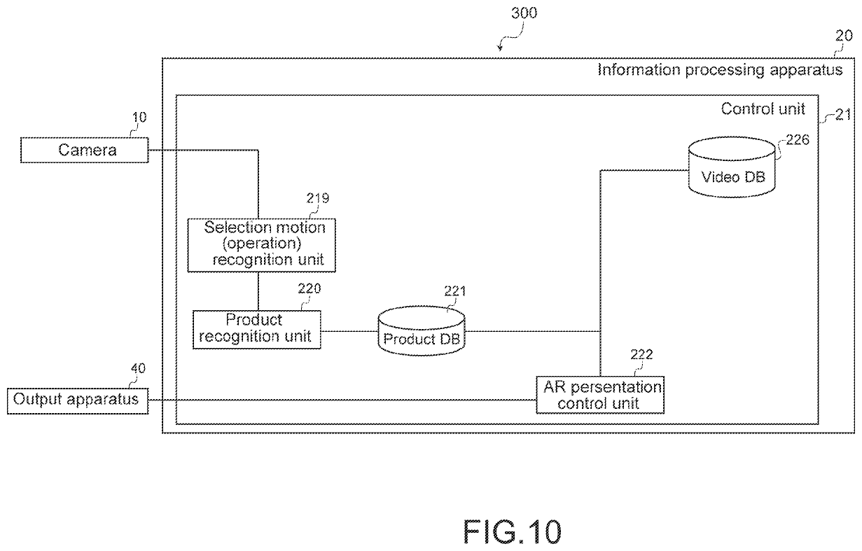

FIG. 10 is a block diagram showing a configuration example of a virtual superimposition system 300 according to a third embodiment of the present technology. Hereinafter, the same components as those of the first embodiment are denoted by the same reference numerals, and a description thereof will be omitted.

The third embodiment is different from the first embodiment in that the target on which the product selected by the user is virtually superimposed is a previously stored video.

The information processing apparatus 20 (control unit 21) according to the third embodiment functionally has a video DB 226. The video DB 226 stores a video that the user has previously viewed (video within capturing range of AR device).

### [Information Processing Method]

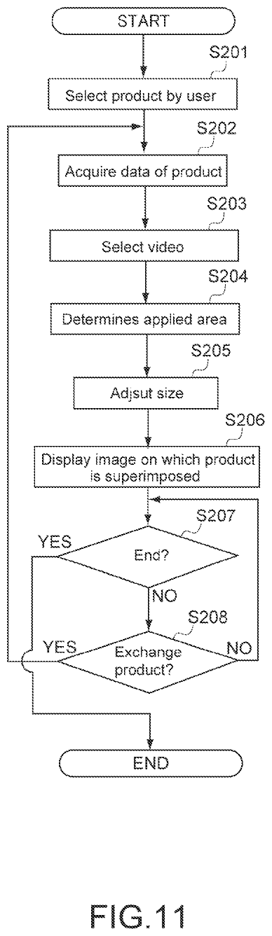

FIG. 11 is a flowchart showing a typical process flow of the information processing apparatus 20 according to the third embodiment. Hereinafter, an outline of processing of the virtual superimposition system 300 will be described with reference to FIG. 11, as appropriate.

First, the user selects a specific product from among a number of products (Step S201). In this case, the user's selection motion may include, for example, picking up, touching, or watching the specific product by the user. The product in the third embodiment is, for example, furniture such as sofa or a small item such as a picture frame, and is an example of a “selected item” in Claims.

Next, the selection motion (operation) recognition unit 219 recognizes what selection motion the user has taken on the basis of the image data acquired from the camera 10 capturing the user's selection motion. On the basis of a recognition result of the selection motion (operation) recognition unit 219, the product recognition unit 220 recognizes what product the user selected is (furniture, small item, or the like), and outputs the recognition result to the product DB 221.

The product DB 221 picks up metadata corresponding to the product recognized by the product recognition unit 220, and outputs the metadata to the AR presentation control unit 222. Thus, the AR presentation control unit 222 acquires the metadata relating to the product selected by the user (Step S202).

The AR presentation control unit 222 selects the video most suitable for the metadata from among the videos stored in the video DB 226 on the basis of the metadata of the product acquired from the product DB 221 (Step S203). The video is, for example, a video in a room of the user, and is an example of a “target stored in advance” in Claims. Next, the AR presentation control unit 222 determines an area to which the image is to be applied in generating the superimposed image (Step S204).

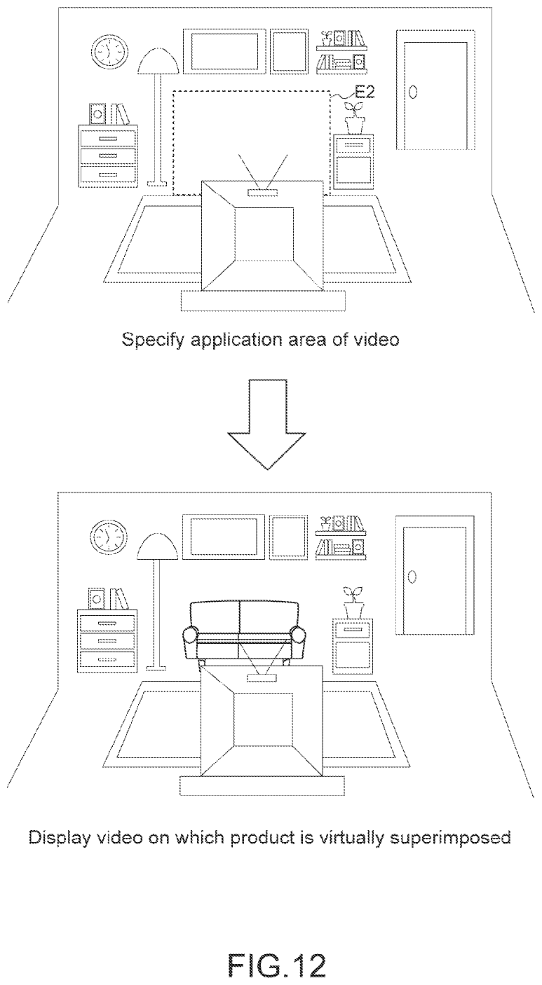

Subsequently, the AR presentation control unit 222 adjusts a scale of the selected video (Step S205), and generates a superimposed image in which the product selected by the user is virtually superimposed on an application area of the adjusted image. Then, the AR presentation control unit 222 displays the superimposed image on the output apparatus 40 (Step S206). Thus, the user can confirm the superimposed image at a place where the product is selected. That is, since the user can confirm the superimposed image without selecting the place, convenience for objectively confirming a state in which the product selected by the user is virtually superimposed is improved. FIG. 12 is a conceptual diagram showing an example in which the product is virtually superimposed on the video viewed by the user in the past. Incidentally, FIG. 12 shows an example in which the product selected by the user is a sofa.

Subsequently, if the user selects a product different from the product selected in Step S201 (YES in Step S208), the AR presentation control unit 222 newly acquires metadata about the product selected by the user from the product DB 221.

Next, by executing the same processing in Steps S202 to S206, the AR presentation control unit 222 generates an image in which a newly selected product is virtually superimposed on the image viewed by the user in the past, and displays the image on the output apparatus 40.

### [Modification]

In the third embodiment, the superimposed image in which the product is virtually superimposed on a past image is presented to the user, but it is not limited thereto. For example, after the user selects a product, the user may be presented with whether or not to purchase the selected product by performing a predetermined motion on the product (e.g., placing the selected product at a specific place (position)). In this case, for example, when the user leaves a specific area (shopping area), the purchased product may be prepared at the exit or delivered to the home.

### <Supplement>

Embodiments of the present technology may include, for example, an information processing apparatus, a system, an information processing method executed by the information processing apparatus or the system, a program for operating the information processing apparatus, and a non-transitory tangible medium in which the program is recorded, as described above.

Further, although the virtual superimposition system 100, 200, or 300 of the present embodiment has been described on the premise of being applied to an AR device for a human, but it is not limited thereto, and the application of the present technology is not especially limited.

In addition, the effects described herein are illustrative or exemplary only and not restrictive. In other words, the present technology may have other effects apparent to those skilled in the art from the description herein together with the above effects or in place of the above effects.

Although preferred embodiments of the present technology have been described in detail above with reference to the accompanying drawings, the present technology is not limited to such examples. It is obvious that a person ordinarily skilled in the art may arrive at various modifications or modifications within the scope of the technical ideas described in Claims, and it is understood that these are also within the technical scope of the art.

The present technology may also have the following structures.

(1)

An information processing apparatus, including a control unit that displays an image superimposed on a display unit such that a wearing object selected by a user is virtually worn on a target different from the user, and determines the target on which the wearing object is virtually superimposed on the basis of at least metadata of the wearing object.

(2)

The information processing apparatus according to (1), in which
the control unit determines the target on which the wearing object is virtually superimposed on the basis of the metadata of the wearing object and body size information of the user.
   (3)

The information processing apparatus according to (1) or (2), in which
the control unit selects a target having a body size similar to a body size of the user as the target on which the wearing object is virtually superimposed.
   (4)

The information processing apparatus according to any one of (1) to (3), in which
the control unit selects a target depending on a type of the wearing object as the target on which the wearing object is virtually superimposed.
   (5)

The information processing apparatus according to any one of (1) to (4), in which
the control unit selects a target depending on a size of each part of the user as the target on which the wearing object is virtually superimposed.
   (6)

The information processing apparatus according to any one of (1) to (5), in which
the control unit acquires metadata of a wearing object newly selected by a motion of the user, and determines the target on which the wearing object is virtually superimposed on the basis of at least the metadata.
   (7)

The information processing apparatus according to any one of (1) to (6), in which
the control unit displays on the display unit an image in which the wearing object is virtually superimposed on a virtual model, which is a target different from the user.
   (8)

The information processing apparatus according to (7), in which
the control unit determines an area in which the virtual model is present depending on the wearing object selected by the user.
   (9)

The information processing apparatus according to (7) or (8), in which
the control unit causes the virtual model to perform a motion depending on the wearing object selected by the user. (10)

The information processing apparatus according to any one of (1) to (9), in which
the control unit displays on the display unit an image in which a selected item selected by the user is virtually superimposed on a previously stored target.

The information processing apparatus according to any one of (1) to (10), in which
the metadata is information about at least one of a type, a size, a color, a material, or a price of the wearing object.
   (12)

An information processing method, including:
determining a target on which a wearing object is virtually superimposed on the basis of at least metadata of the wearing object; and
displaying on a display unit an image superimposed such that the wearing object selected by a user is virtually worn on the target different from the user is displayed.
   (13)

A program that causes an information processing apparatus to execute the steps of:
determining a target on which a wearing object is virtually superimposed on the basis of at least metadata of the wearing object; and
displaying on a display unit an image superimposed such that the wearing object selected by a user is virtually worn on the target different from the user.

### REFERENCE SIGNS LIST

10 camera

20 information processing apparatus

21 control unit

30 microphone

40 output apparatus

100, 200, 300 virtual superimposition system

1. An information processing apparatus, comprising:
a control unit that displays an image superimposed on a display unit such that a wearing object selected by a user is virtually worn on a target different from the user, and determines the target on which the wearing object is virtually superimposed on a basis of at least metadata of the wearing object.

2. The information processing apparatus according to claim 1, wherein
the control unit determines the target on which the wearing object is virtually superimposed on a basis of the metadata of the wearing object and body size information of the user.

3. The information processing apparatus according to claim 1, wherein
the control unit selects a target having a body size similar to a body size of the user as the target on which the wearing object is virtually superimposed.

4. The information processing apparatus according to claim 1, wherein
the control unit selects a target depending on a type of the wearing object as the target on which the wearing object is virtually superimposed.

5. The information processing apparatus according to claim 4, wherein
the control unit selects a target depending on a size of each part of the user as the target on which the wearing object is virtually superimposed.

6. The information processing apparatus according to claim 1, wherein
the control unit acquires metadata of a wearing object newly selected by a motion of the user, and determines the target on which the wearing object is virtually superimposed on a basis of at least the metadata.

7. The information processing apparatus according to claim 1, wherein
the control unit displays on the display unit an image in which the wearing object is virtually superimposed on a virtual model, which is a target different from the user.

8. The information processing apparatus according to claim 7, wherein
the control unit determines an area in which the virtual model is present depending on the wearing object selected by the user.

9. The information processing apparatus according to claim 7, wherein
the control unit causes the virtual model to perform a motion depending on the wearing object selected by the user.

10. The information processing apparatus according to claim 1, wherein
the control unit displays on the display unit an image in which a selected item selected by the user is virtually superimposed on a previously stored target.

11. The information processing apparatus according to claim 1, wherein
the metadata is information about at least one of a type, a size, a color, a material, or a price of the wearing object.

12. An information processing method, comprising:
determining a target on which a wearing object is virtually superimposed on a basis of at least metadata of the wearing object; and
displaying on a display unit an image superimposed such that the wearing object selected by a user is virtually worn on the target different from the user is displayed.

13. A program that causes an information processing apparatus to execute the steps of:
determining a target on which a wearing object is virtually superimposed on a basis of at least metadata of the wearing object; and
displaying on a display unit an image superimposed such that the wearing object selected by a user is virtually worn on the target different from the user.
